(19) United States
(12) Patent Application Publication
(10) Pub. No.: US 2002/0164992 A1
(43) Pub. Date: Nov. 7, 2002

(54) Method and apparatus for data-dependant mobile network routing

(76) Inventor: James J. Olsen, Concord, MA (US)

Correspondence Address: DEVINE, MILLIMET & BRANCH, P.A., 111 AMHERST STREET, BOX 719, MANCHESTER, NH, 03105, US

(21) Appl. No.: 09/850,606

(22) Filed: May 7, 2001

(51) Int. Cl. H04Q 7/20

(52) U.S. Cl. 455/452; 455/453; 455/445

(57) ABSTRACT

The present invention is a data routing method for transmitting a data between communication platforms using a priority code in a type table. The first step of the present method is predetermining available data types, available priority codes, and a channel table. This first step may only be required once for a device using the present method with the remainder of the steps being performed on multiple occasions. The next step is inputting data into a transmission means. Data may include voice communication, computer accumulated information, or any other material that can be electronically transmitted. The next step, normally performed synchronously with the previous step is inputting a data type. The data type identifies the type of communication being transmitted and may only be chosen from the predetermined range of data types. The next step is determining priority code based on the data type. Every available data type must be pre-assigned at least one priority code. The next step is choosing at least one transmission channel from the channel table based on the priority code. Every priority code is pre-assigned at least one transmission channel in the channel table. The final step is transmitting the data along at least one chosen transmission channel.

### FIELD OF THE INVENTION

The present invention relates to the field of telecommunications. More specifically, the present invention relates to the field of wireless data communications from mobile platforms. Even more specifically, the present invention relates to the field of ‘least-cost routing’ of wireless data communications from mobile platforms to fixed systems.

### BACKGROUND OF THE INVENTION

When one is faced with the problem of wireless data communication from a mobile system (such as a truck) to a fixed office computer system, it is often the case that more than one communications channel between the mobile and fixed systems will be required. In this case, one must choose which channel to use for each message to be transmitted. The process of making such a choice is commonly called routing.

When multiple channels are implemented, they will generally have different cost, performance, and coverage characteristics. Existing systems, such as those created by Norcom or Broadbeam, seek to implement ‘least-cost routing’‘, where each message is transmitted on the least expensive channel available at that time. This type of routing decision is required because a mobile system will, as it proceeds from one point to another, pass into and out of the coverage area of one or another communications channel.

Generally, the wireless data communications channels providing the widest coverage (such as satellites) are more expensive and the channels providing more restricted coverage (such as Mobitex) are less expensive. The least-cost routing system will therefore generally use a relatively cheap narrow-coverage channel whenever possible, and switch over to the more expensive wide-area channel when the less expensive channels are unavailable.

The present method of routing decision-making has several problems. One problem is that communications consumers determine are low priority may nevertheless be transmitted over more expensive wide-area channels, without the ability to make a decision regarding the cost effectiveness of the communications means. Some communications are of a low enough priority that only the usage of the least expensive communications method available would make transmitting the communication cost effective. Present routing systems do not account for this economic concern.

Another problem with the present routing method is time-sensitivity is not taken into account. Some communications need not be acted upon shortly after transmission, thereby making the information not time-sensitive. However the present routing method makes sending out the communication immediately a priority over other channel decision-making factors. Therefore the present method frequently wastes money on high cost communications for non-priority communications.

A final problem with the present routing method is it does not take into account communications consumers decide are high priority. High priority communications may get transmitted over a less reliable, low cost communications means. The criticality of some information demands the most reliable communications means, but the present routing method does not account for these demands. Therefore the present routing method is not optimal for high priority communications.

### SUMMARY OF THE INVENTION

The present invention results from the realization that a routing method that categorizes data to be transmitted can identify the priority level of communications and transmit the communications in a cost-effective manner, or store the communication until the mobile platform can utilize a more cost effective method of transmission.

It is therefore an object of the present invention to transmit all communications by the most cost effective means available.

It is a further object of the present invention that non-time sensitive communications can be stored in the router until the most cost-effective method of transmission becomes available.

It is a further object of the present invention that high priority communications can be sent using redundant transmission methods to ensure reliable and prompt reception.

### BRIEF DESCRIPTION OF THE DRAWINGS

The novel features believed characteristic of the invention are set forth in the claims. The invention itself however, as well as other features and advantages thereof, will be best understood by reference to the description which follows, read in conjunction with the accompanying drawings, wherein:

FIG. 1 shows a flow chart of one embodiment of the present invention.

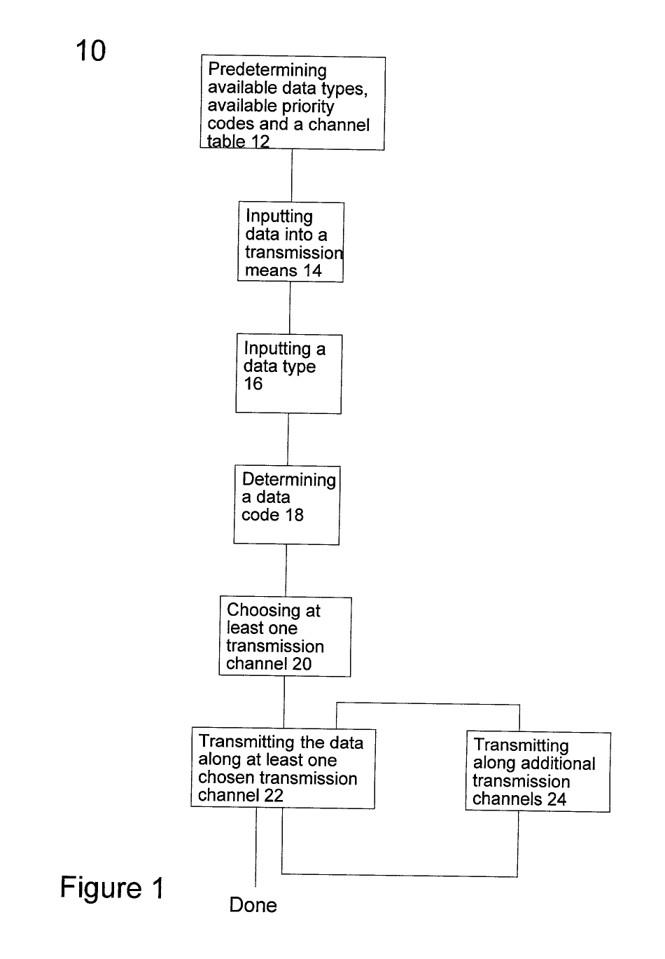

FIG. 2 shows a flow chart of another embodiment of the present invention.

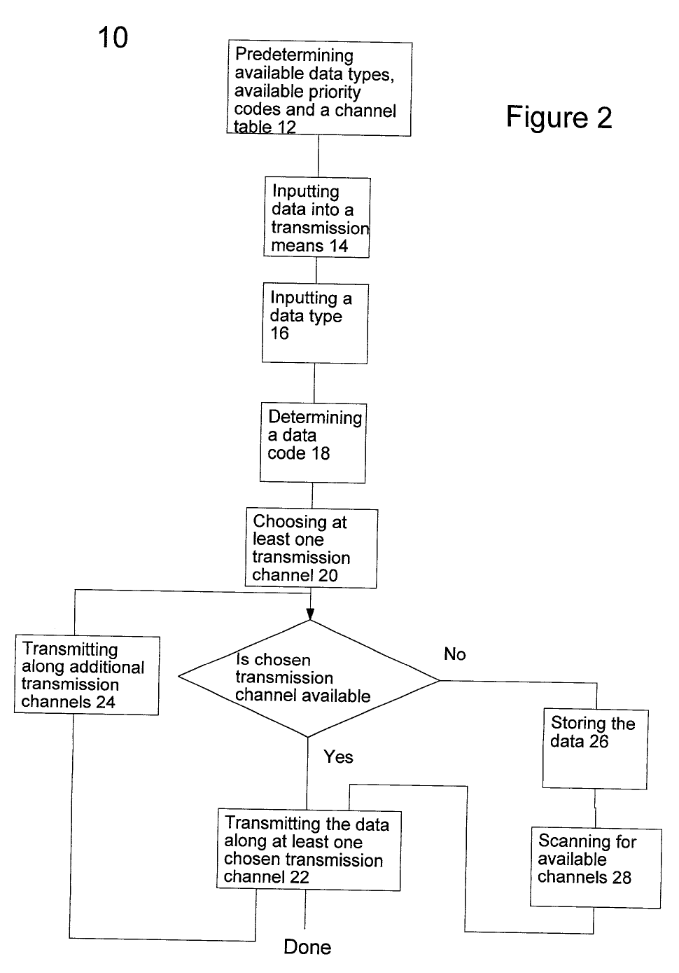

FIG. 3 shows a flow chart of another embodiment of the present

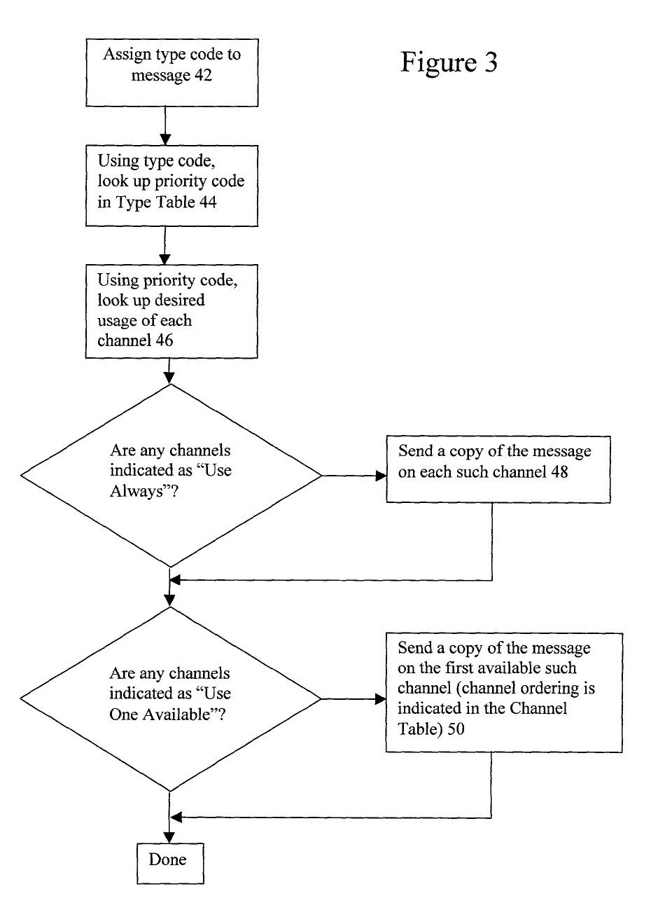

FIG. 4 shows a one-line diagram of one embodiment of the present invention.

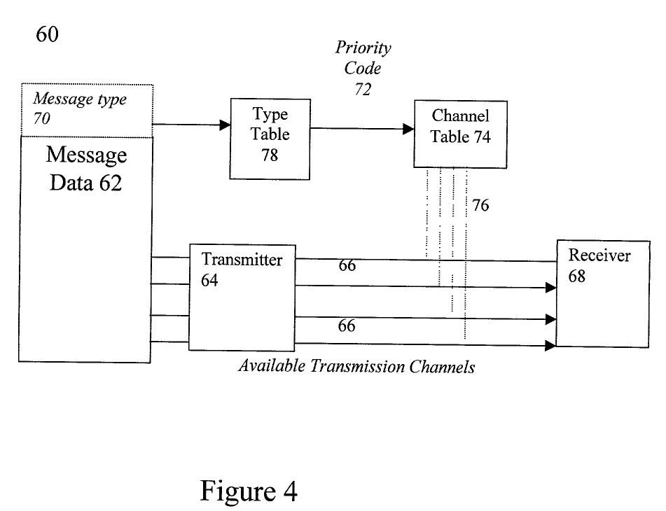

### DETAILED DESCRIPTION OF THE INVENTION

The present invention is a data routing method 10 for transmitting data between communication platforms. The first step of the present method 10 is predetermining 12 available data types, available priority codes, and a channel table. This first step may only be required once for a device using the present method 10 with the remainder of the steps being performed on multiple occasions. The next step is inputting data 14 into a transmission means. Data may include voice communication, computer accumulated information, or any other material that can be electronically or telephonically transmitted. The next step, normally performed synchronously with the previous step is inputting 16 a data type. The data type identifies the type of communication being transmitted and may only be chosen from the predetermined 12 range of data types. The next step is determining 18 a priority code based on the data type. Every available data type must be pre-assigned at least one priority code during the predetermining 12 step. The next step is choosing 20 at least one transmission channel from the channel table based on the priority code. Every priority code is pre-assigned at least one transmission channel in the channel table during the predetermining 12 step. The final step is transmitting 22 the data along at least one chosen 20 transmission channel.

The present method 10 contains a number of narrow embodiments. One narrower embodiment further includes transmitting 24 the data along more than one transmission channel. The present embodiment allows for the possibility of using multiple channels for redundant transmission, which allows a data receiver to verify the message was not corrupted during transmission.

Another narrow embodiment adds multiple steps to the inventive method 10. The first step is storing 26 the data when no chosen 20 transmission channel is available. The next step is scanning 28 periodically for available transmission channels until at least one of the chosen 20 transmission channels is available. The final step to this narrow embodiment is transmitting 22 the data along at least one chosen 20 transmission channel. This narrow embodiment may also involve continuing to save the data when redundant transmission is sought and at least one chosen 20 transmission channel remains unavailable.

The present invention can also be described as a data routing method 40 for transmitting a message between communication locations using a priority code in a type table. The method 40 includes assigning 42 a type code to the message. A message is any material that can be transmitted electronically or telephonically. The next step to the method 40 is using 44 the type code to determine the priority code from the type table. Then the method 40 requires using 46 the priority code to look up a desired usage of each channel. The final step to the method 40 is sending 48 the message along each channel the priority code indicates is to always be used and sending 50 the message along a first available channel when the priority code indicates using a first available channel. Understood in this final step of the method 40 is that ‘each channel’ includes the possibility that the priority code indicates no channel is to always be used in sending 48.

The present invention is also a data routing apparatus 60 for transmitting a message 62 between communication platforms using a transmitter 64 capable of transmitting along multiple channels 66 and a receiver 68 capable of receiving from at least one of the multiple channels 66. The apparatus 60 includes a type code 70 assigned to the message 62. A priority code 72 is determined by the type code 70. The apparatus 60 also includes a channel table 74 for determining along which of the channels 66 the transmitter 64 will transmit according to the priority code 72. The final element of the apparatus 60 is a channel assigner 76 for indicating for the transmitter 64 which of the channels 66 to use based on the channel table 74 determination.

A narrow embodiment of the inventive apparatus 60 involves having the priority code 72 further determined by a type table 78 in conjunction with the type code 70. Another narrow embodiment of the inventive apparatus 60 involves having, depending on the priority code 72, the channel table 74 determine to do one of the group of: (1) use a specific channel; and (2) use the first available channel from a series of specified channels.

We claim:

1. A data routing method for transmitting a message between communication platforms using a priority code in a type table, said method comprising:
predetermining available type codes, available priority codes, and a channel table;
inputting data into a transmission means;
inputting a data type;
determining priority code based on the data type;
choosing at least one transmission channel from the channel table based on the priority code; and
transmitting the data along at least one chosen transmission channel.

2. The method of claim 1 further comprising transmitting the data along multiple transmission channels.

3. The method of claim 1 further comprising:
storing the data when no chosen transmission channel is available;
scanning periodically for available transmission channels until at least one of the chosen transmission channels is available; and
transmitting the data along at least one chosen transmission channel.

4. A data routing method for transmitting a message between communication platforms using a priority code in a type table, said method comprising:
assigning a type code to the message;
using the type code to determine the priority code from the type table;
using the priority code to look up a desired usage of each channel;
sending the message along each channel the priority code indicates is to always be used when the priority code indicates at least one channel is to always be used; and
sending the message along a first available channel when the priority code indicates using a first available channel.

5. The method of claim 4 further comprising:
storing the message when a channel the priority code indicates is to always be used is unavailable; and
sending the message along said channel the priority code indicates is to always be used when said channel becomes available.

6. A data routing apparatus for transmitting a message between communication locations using a transmitter capable of transmitting along multiple channels and a receiver capable of receiving from multiple channels, said apparatus comprising:
a type code assigned to the message;
a priority code determined by the type code;
a channel table for determining along which channel the transmitter will transmit according to the priority code; and
a channel assigner for indicating for the transmitter which channel to use based on the channel table determination.

7. The apparatus of claim 6 wherein the priority code is further determined by a type table in conjunction with the type code.

8. The apparatus of claim 6 wherein, depending on the priority code, the channel table determines one of the group of:
use a specific channel; and
use the first available channel from a series of specified channels.
